(19) United States
(12) Patent Application Publication
(10) Pub. No.: US 2016/0254974 A1
(43) Pub. Date: Sep. 1, 2016

(54) TCP Layer with Higher Level Testing Capabilities

(71) Applicant: Brocade Communications Systems, Inc., San Jose, CA (US)

(72) Inventors: Douglas Dunn, Brooklyn Park, MN (US); Andy Dooley, Rogers, MN (US); Isaac Larson, Minneapolis, MN (US)

(21) Appl. No.: 14/632,762

(22) Filed: Feb. 26, 2015

(51) Int. Cl. H04L 12/26; H04L 29/06

(52) U.S. Cl. CPC H04L 43/0829; H04L 69/16

(57) ABSTRACT

A TCP layer that is able to defeat or disable retransmit and recovery operations upon request from a diagnostic program. This allows the missing packets and the like to be determined by the diagnostic program as the TCP layer will not hide the packet loss by doing retransmission operations. The TCP layer otherwise operates normally, allowing better analysis of the operation of the TCP layer and the network.

### BACKGROUND OF THE INVENTION

1. Field of the Invention

The invention relates to network transmission using the TCP protocol.

2. Description of the Related Art

A storage area network (SAN) may be implemented as a high-speed, special purpose network that interconnects different kinds of data storage devices with associated data servers on behalf of a large network of users. Typically, a storage area network includes high performance switches as part of the overall network of computing resources for an enterprise. The storage area network is usually clustered in close geographical proximity to other computing resources, such as mainframe computers, but may also extend to remote locations for backup and archival storage using wide area network carrier technologies. Fibre Channel networking is typically used in SANs although other communications technologies may also be employed, including Ethernet and IP-based storage networking standards (e.g., iSCSI, FCIP (Fibre Channel over Internet Protocol), etc.).

As used herein, the term “Fibre Channel” refers to the Fibre Channel (FC) family of standards (developed by the American National Standards Institute (ANSI)) and other related and draft standards. In general, Fibre Channel defines a transmission medium based on a high speed communications interface for the transfer of large amounts of data via connections between varieties of hardware devices.

FC standards have defined limited allowable distances between FC switch elements. Fibre Channel over IP (FCIP) refers to mechanisms that allow the interconnection of islands of FC SANs over IP-based (internet protocol-based) networks to form a unified SAN in a single FC fabric, thereby extending the allowable distances between FC switch elements to those allowable over an IP network. For example, FCIP relies on IP-based network services to provide the connectivity between the SAN islands over local area networks (LANs), metropolitan area networks (MANs), and wide area networks (WANs). Accordingly, using FCIP, a single FC fabric can connect physically remote FC sites allowing remote disk access, tape backup, and live mirroring.

In an FCIP implementation, FC traffic is carried over an IP network through a logical FCIP tunnel. Each FCIP entity on either side of the IP network works at the session layer of the OSI model. The FC frames from the FC SANs are encapsulated in IP packets and transmission control protocol (TCP) segments and transported in accordance with the TCP layer in one or more TCP sessions. For example, an FCIP tunnel is created over the IP network and a TCP session is opened in the FCIP tunnel.

One common problem in TCP/IP networks is packet loss. Each packet must be acknowledged. Usually this is done sequentially as the packets arrive, but in certain cases packets may be lost or corrupted and following packets received correctly.

Standard TCP has retransmission and recovery mechanisms to quickly recover from packet loss on a network. However, this packet retransmission and recovery done at the TCP layer may hinder diagnosis by diagnostic and testing applications and the like that execute at the application layer, above the TCP layer. As the TCP layer will obtain the missing segments and then deliver segments in order when any missing segments have been received, the diagnostic application cannot determine that packet loss has been occurring, thus limiting diagnostic value in that area.

A diagnostic program would have to incorporate at least its own TCP layer if this hidden information was desired. This makes the diagnostic program more complicated and generally also limits the use of the diagnostic program to limited situations and platforms. Therefore diagnostic programs are more costly and less transferable than is desirable.

### SUMMARY OF THE INVENTION

To aid in operations with application layer diagnostic and testing programs, a TCP layer according to the present invention is able to defeat or disable retransmit and recovery operations upon request from the diagnostic program. This allows the missing packets and the like to be determined by the diagnostic program as the TCP layer will not hide the packet loss by doing retransmission operations. The TCP layer otherwise operates normally, allowing better analysis of the operation of the TCP layer and the network. This allows diagnostic programs to operate entirely at the application layer with only minor modifications between platforms.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 illustrates an example FCIP configuration over an IP network.

FIG. 2 illustrates block diagrams of example IP gateway devices communicating over an IP network.

FIG. 3A illustrates a logical block diagram of the network and TCP/IP and application stacks for a transmitter and a receiver with normal lossless packet flow.

FIG. 3B illustrates a logical block diagram of the network and TCP/IP and application stacks for a transmitter and a receiver with lossy packet flow.

FIG. 3C illustrates a logical block diagram of the network and TCP/IP and application stacks for a transmitter and a receiver according to the present invention.

FIG. 4 is a network sequence diagram of normal TCP retransmission operation.

FIG. 5 is a network sequence diagram of TCP operation according to the present invention.

FIG. 6A is a flowchart of transmitter operation according to the present invention.

FIG. 6B is a flowchart of receiver operation according to the present invention.

### DETAILED DESCRIPTION OF THE PREFERRED EMBODIMENTS

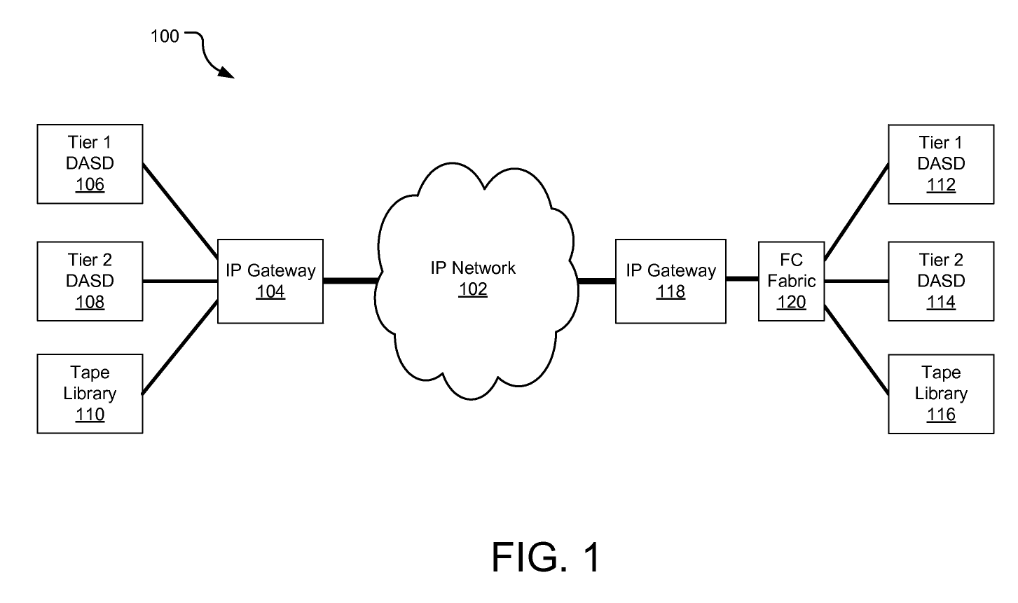

FIG. 1 illustrates an example FCIP configuration 100 over an IP network 102. An IP gateway device 104 (e.g., an FCIP extender), couples example FC source nodes (e.g., Tier 1 Direct Access Storage Device (DASD) 106, Tier 2 DASD 108, and a tape library 110) to the IP network 102 for communication to example FC destination nodes (e.g., Tier 1 DASD 112, Tier 2 DASD 114, and a tape library 116, respectively) through an IP gateway device 118 (e.g., another FCIP extender) and an FC fabric 120. Generally, an IP gateway device interfaces to an IP network. In the specific implementation illustrated in FIG. 1, the IP gateway device 118 interfaces between an IP network and an FC fabric, but other IP gateway devices may include tape extension devices, Ethernet network interface controllers (NICs), host bus adapters (HBAs), and director level switches). An example application of such an FCIP configuration would be a remote data replication (RDR) scenario, wherein the data on the Tier 1 DASD 106 is backed up to the remote Tier 1 DASD 112, the data on the Tier 2 DASD 108 is backed up to the remote Tier 2 DASD 114, and data on the tape library no is backed up to the remote tape library 116. In addition to the data streams, a control stream is also communicated between the IP gateway devices 104 and 118 to pass class-F control frames.

The IP gateway device 104 encapsulates FC packets received from the source nodes 106, 108, and 110 in TCP segments and IP packets and forwards the TCP/IP-packet-encapsulated FC frames over the IP network 102. The IP gateway device 118 receives these encapsulated FC frames from the IP network 102, “de-encapsulates” them (i.e., extracts the FC frames from the received IP packets and TCP segments), and forwards the extracted FC frames through the FC fabric 120 to their appropriate destination nodes 112, 114, and 116. It should be understood that each IP gateway device 104 and 118 can perform the opposite role for traffic going in the opposite direction (e.g., the IP gateway device 118 doing the encapsulating and forwarding through the IP network 102 and the IP gateway device 104 doing the de-encapsulating and forwarding the extracted FC frames through an FC fabric). In other configurations, an FC fabric may or may not exist on either side of the IP network 102. As such, in such other configurations, at least one of the IP gateway devices 104 and 118 could be a tape extender, an Ethernet NIC, etc. In other configurations the IP gateway may pass Ethernet TCP/IP traffic as well, as described in U.S. Pat. No. 8,756,602, entitled “Virtual Machine and Application Registration Over Local and Wide Area Networks Without Timeout,” which is hereby incorporated by reference.

Each IP gateway device 104 and 118 includes an IP interface, which appears as an end station in the IP network 102. Each IP gateway device 104 and 118 also establishes a logical FCIP tunnel through the IP network 102. The IP gateway devices 104 and 118 implement the FCIP protocol and rely on the TCP layer to transport the TCP/IP-packet-encapsulated FC frames over the IP network 102. Each FCIP tunnel between two IP gateway devices connects two TCP end points in the IP network 102. Viewed from the FC perspective, pairs of switches export virtual E_PORTs or virtual EX_PORTs (collectively referred to as virtual E_PORTs) that enable forwarding of FC frames between FC networks, such that the FCIP tunnel acts as an FC InterSwitch Link (ISL) over which encapsulated FC traffic flows.

The FC traffic is carried over the IP network 102 through the FCIP tunnel between the IP gateway device 104 and the IP gateway device 118 in such a manner that the FC fabric 102 and all purely FC devices (e.g., the various source and destination nodes) are unaware of the IP network 102. As such, FC datagrams are delivered in such time as to comply with applicable FC specifications.

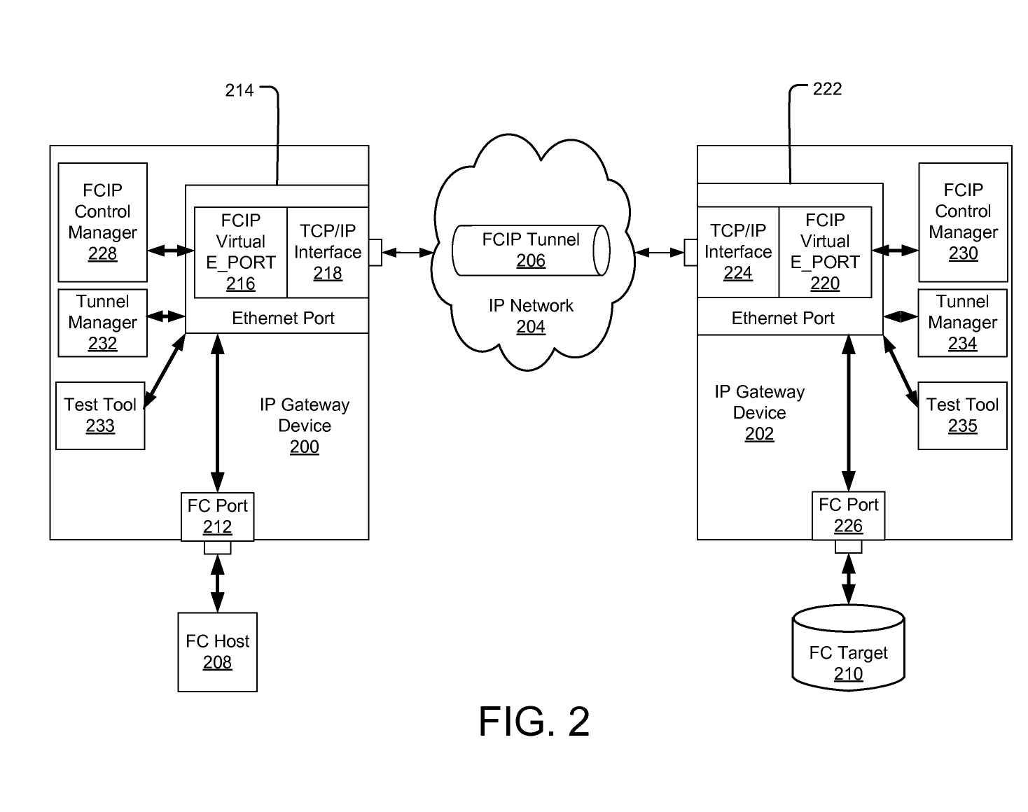

FIG. 2 illustrates example IP gateway devices 200 and 202 (e.g., FCIP extension devices in the illustrated example) communicating over an IP network 204. An FC host 208 is configured to send data to an FC target 210 through the IP network 204.

The FC host 208 couples to an FC port 212 of the IP gateway device 200. The coupling may be made directly between the FC port 212 and the FC host 208 or indirectly through an FC fabric (not shown). The FC port 212 receives FC frames from the FC host 208 and forwards them to an Ethernet port 214, which includes an FCIP virtual E_PORT 216 and a TCP/IP interface 218 coupled to the IP network 204. The FCIP virtual E_PORT 216 acts as one side of the logical ISL formed by an FCIP tunnel 206 over the IP network 204. An FCIP virtual E_PORT 220 in the IP gateway device 202 acts as the other side of the logical ISL. The Ethernet port 214 encapsulates each FC frame received from the FC port 212 in a TCP segment and an IP packet shell and forwards them over the IP network 204 through the FCIP tunnel 206.

The FC target 210 couples to an FC port 226 of the IP gateway device 202. The coupling may be made directly between the FC port 226 and the FC host 210 or indirectly through an FC fabric (not shown). An Ethernet port 222 receives TCP/IP-packet-encapsulated FC frames over the IP network 204 from the IP gateway device 200 via a TCP/IP interface 224. The Ethernet port 222 de-encapsulates the received FC frames and forwards them to an FC port 226 for communication to the FC target device 210.

It should be understood that data traffic can flow in either direction between the FC host 208 and the FC target 210. As such, the roles of the IP gateway devices 200 and 202 may be swapped for data flowing from the FC target 210 and the FC host 208.

Tunnel manager modules 232 and 234 (e.g., circuitry, firmware, software or some combination thereof) of the IP gateway devices 200 and 202 set up and maintain the FCIP tunnel 206. Either IP gateway device 200 or 202 can initiate the FCIP tunnel 206, but for this description, it is assumed that the IP gateway device 200 initiates the FCIP tunnel 206. After the Ethernet ports 214 and 222 are physically connected to the IP network 204, data link layer and IP initialization occur. The TCP/IP interface 218 obtains an IP address for the IP gateway device 200 (the tunnel initiator) and determines the IP address and TCP port numbers of the remote IP gateway device 202. The FCIP tunnel parameters may be configured manually, discovered using Service Location Protocol Version 2 (SLPv2), or designated by other means. The IP gateway device 200, as the tunnel initiator, transmits an FCIP Special Frame (FSF) to the remote IP gateway device 202. The FSF contains the FC identifier and the FCIP endpoint identifier of the IP gateway device 200, the FC identifier of the remote IP gateway device 202, and a 64-bit randomly selected number that uniquely identifies the FSF. The remote IP gateway device 202 verifies that the contents of the FSF match its local configuration. If the FSF contents are acceptable, the unmodified FSF is echoed back to the (initiating) IP gateway device 200. After the IP gateway device 200 receives and verifies the FSF, the FCIP tunnel 206 can carry encapsulated FC traffic.

The FCIP tunnel 206 maintains frame ordering. The egress transmission sequence of frames within an individual flow will remain in the same order as their ingress sequence to that flow. Because the flows are based on FC initiator and FC target, conversational frames between two FC devices will remain in proper sequence. A characteristic of TCP is to maintain sequence order of bytes transmitted before delivery to upper layer protocols. As such, the IP gateway device at the remote end of the FCIP tunnel 206 is responsible for reordering data frames received from the various TCP sessions before sending them up the communications stack to the FC application layer. The IP gateway devices 200, 202 also interact to provide the retransmission and recovery features of the TCP protocol using the TCP/IP interfaces 218, 224.

Each IP gateway device 200 and 202 includes an FCIP control manager (see FCIP control managers 228 and 230), which generate the class-F control frames for the control data stream transmitted through the FCIP tunnel 206 to the FCIP control manager in the opposing IP gateway device. Class-F traffic is connectionless and employs acknowledgement of delivery or failure of delivery. Class-F is employed with FC switch expansion ports (E_PORTS) and is applicable to the IP gateway devices 200 and 202, based on the FCIP virtual E_PORT 216 and 220 created in each IP gateway device. Class-F control frames are used to exchange routing, name service, and notifications between the IP gateway devices 200 and 202, which join the local and remote FC networks into a single FC fabric. However, the described technology is not limited to combined single FC fabrics and is compatible with FC routed environments and is also useful in environments that are connected by an FCIP link.

The IP gateway devices 200 and 202 emulate raw FC ports (e.g., VE_PORTs or VEX_PORTs) on both ends of the FCIP tunnel 206. For FC I/O data flow, these emulated FC ports support ELP (Exchange Link Parameters), EFP (Exchange Fabric Parameters, and other FC-FS (Fibre Channel-Framing and Signaling) and FC-SW (Fibre Channel-Switched Fabric) protocol exchanges to bring the emulated FC E_PORTs online. After the FCIP tunnel 206 is configured and the TCP sessions are created for an FCIP connection in the FCIP tunnel, the IP gateway devices 200 and 202 will activate the logical ISL over the FCIP tunnel. When the ISL has been established, the logical FC ports appear as virtual E_PORTs in the IP gateway devices 200 and 202. For FC fabric services, the virtual E_PORTs emulate regular E_PORTs, except that the underlying transport is TCP/IP over an IP network, rather than FC in a normal FC fabric. Accordingly, the virtual E_PORTs 216 and 220 preserve the “semantics” of an E_PORT.

As various problems can occur on network connections, such as those through the IP network 204, having diagnostic programs or diagnostics capability is helpful. To this end the IP gateway devices 200, 202 include a test tool 233, 235. The test tool 233, 235 interfaces with the Ethernet port 214, 222, and more specifically for this discussion, with the TCP/IP interface 218, 224, to allow analysis of the IP network 204. In the preferred embodiment the TCP/IP interface 218, 224 has been modified from a standard TCP/IP interface to allow for improved diagnostic capabilities in conjunction with the test tool 233, 235. Following is a summary of the similarities and differences between the modified TCP/IP interface, also known as TCP Lite, according to the present invention and a standard TCP/IP interface.

Similarities:

TCP Lite shares the same header as standard TCP. TCP Lite and standard TCP can both be active on a single port at the same time, so TCP Lite uses the same header as Standard TCP, but the source and destination ports being used for TCP Lite must not be used for Standard TCP on the same interface and TCP Lite and standard TCP need to have different listen ports so as to not conflict.

TCP Lite uses the same method for connection establishment and connection termination.

TCP Lite has the same basic state machine as Standard TCP, with differences described in more detail below.

TCP Lite uses advertised windows.

TCP Lite uses a negotiated window scale in SYN processing.

TCP Lite sequences transmitted data.

TCP Lite sends acknowledgement packets.

TCP Lite has a keep-alive timeout.

TCP Lite uses a checksum field in the header.

TCP Lite can be encrypted

TCP Lite uses maximum segment size (MSS) negotiation in SYN processing.

TCP Lite supports the time-stamping option.

TCP Lite calculates the Round Trip Time.

Differences:

TCP Lite does not guarantee data transmitted.

TCP Lite does not guarantee any order on data transmitted.

TCP Lite uses the sequence in data to detect out of order and network congestion.

TCP Lite uses the SACK optional TCP header to indicate network congestion, not for the indication of missing data.

TCP Lite does not have a retransmission timeout.

TCP Lite does not retransmit data packets, only SYN and FIN packets.

This can be summarized as TCP Lite uses the same method for connection bring-up and tear down as Standard TCP, but when data is passed TCP Lite does not require the acknowledgement of any data. The only ACK required is on packets with the SYN or FIN bit set though this preferred embodiment does provide ACKs. Once the connection has been established and the SYN/SYN-ACK is complete, the retransmit timeout timer will be disabled. Only once a FIN has been sent will a retransmission timeout be started on the FIN sequence number. TCP Lite has the same state machine as standard TCP except that in the Established state the acknowledgement and retransmission of lost data will change as described below. TCP Lite uses sequence (SEQ) and acknowledgement (ACK) numbers in every packet. TCP Lite preferably sends ACK packets to the transmitting side on receipt of a packet, but will always ACK the highest sequence number received. TCP Lite sends an ACK with the highest sequence number received, but if the packet received has a sequence number higher or lower, meaning out of sequence, it sends an ACK with SACK information. The SACK optional header describes how far the received packet is away from the next expected packet. This is an indication to the transmitting side that network re-ordering or packet loss has occurred. The transmitting side in TCP Lite uses the receipt of the negative acknowledgement to indicate network re-ordering or packet loss. TCP Lite starts a counter and if the number of negative acknowledgements are received in a row is over a threshold, then network congestion has occurred. In standard TCP this is the fast retransmission threshold, but in TCP Lite it is only used to indicate network congestion. The data queues for TCP Lite are similar to the standard TCP segment queues, except for the difference in that data in the RX queue is queued in the order it is received. Standard TCP orders the segments into the RX queue to guarantee in-order delivery. TCP Lite has no in-order guarantee, so data is queued and delivered to the RX application in the order it was received from the network.

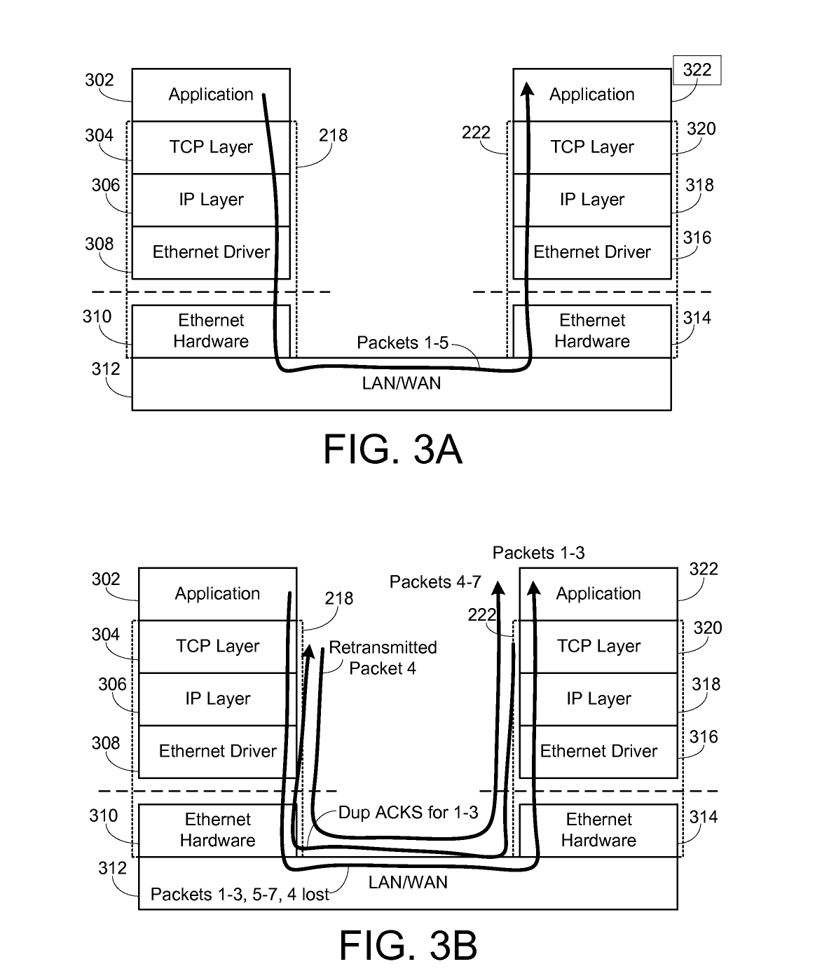

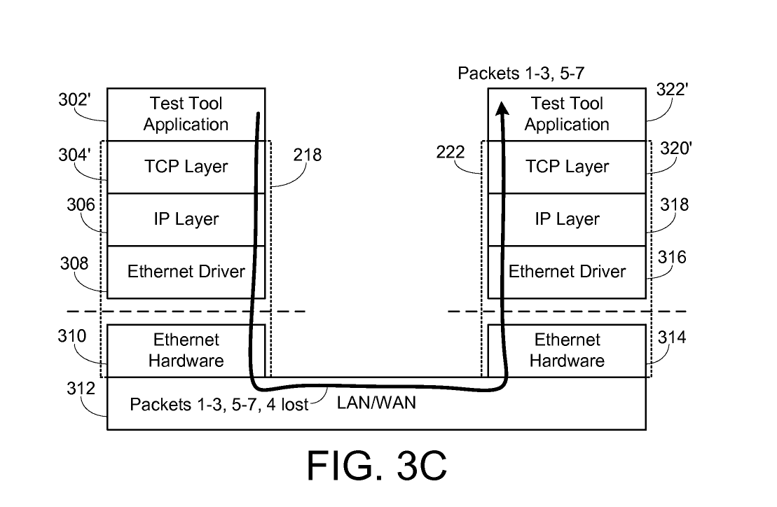

FIGS. 3A-3C illustrate the differences. In FIG. 3A, normal, conventional operation is shown. A transmitting application 302 provides data blocks to a transmitting TCP layer 304. The TCP layer 304 forms TCP segments, which are provided to an IP layer 306. The IP layer 306 forms IP packets, which are provided to an Ethernet driver 308. The Ethernet driver 308 in conjunction with Ethernet hardware 310, such as a network interface card (NIC) or converged network adapter (CNA), form Ethernet packets. The Ethernet hardware 310 provides the Ethernet packet to a LAN/WAN 312, which transmits the packet across the network. The LAN/WAN 312 provides the packet in conjunction with an Ethernet driver 316 strips the Ethernet header to produce an IP packet. The IP packet is provided to a receiving IP layer 318. The IP layer 318 removes the IP header and provides the resulting TCP segment to a receiving TCP layer 320. The TCP layer 320 removes the TCP header and provides the data blocks to a receiving application 322. In the illustrated transfer of FIG. 3A, packets 1-5 are transmitted in order and without any packets getting lost, so the packets 1-5 are simply delivered to the receiving application in order without delays or reordering.

For cross-reference to FIG. 2, the TCP layer 304, the IP layer 306, the Ethernet driver 308 and the Ethernet hardware 310 are the TCP/IP interface 218 while the TCP layer 320, the IP layer 318, the Ethernet driver 316 and the Ethernet hardware 314 are the TCP/IP interface 222.

FIG. 3B illustrates operation when packet 4 is lost in transit in the LAN/WAN. The receiving TCP layer 320 provides DUP ACKs for packets 1-3 when it receives packets 5-7. As this number of DUP ACKs meets or exceeds the number needed to trigger fast retransmission, the transmitting TCP layer 304 retransmits packet 4. When retransmitted packet 4 is received by the receiving TCP layer 320, packets 4-7 are provided to the receiving application 322. Thus, while the receiving application 322 receives all of the packets in order, there is a delay and the receiving application 322 is not aware of the loss of packet 4.

FIG. 3C illustrates operation according to the present invention. Packets 1-7 are provided from the transmitting Ethernet hardware 310 but packet 4 is lost in the LAN/WAN 312. A receiving TCP layer 320′, a modified version of the TCP layer 320, simply provides the packets 1-3 and 5-7 to a receiving application 322′, such as the test tool 233, 235, as the packets are received. No DUP ACKs are sent and no retransmission of packet 4 is done. In this manner the receiving application 322′ can better determine the relative timing of the packets and can also readily determine that a packet was lost.

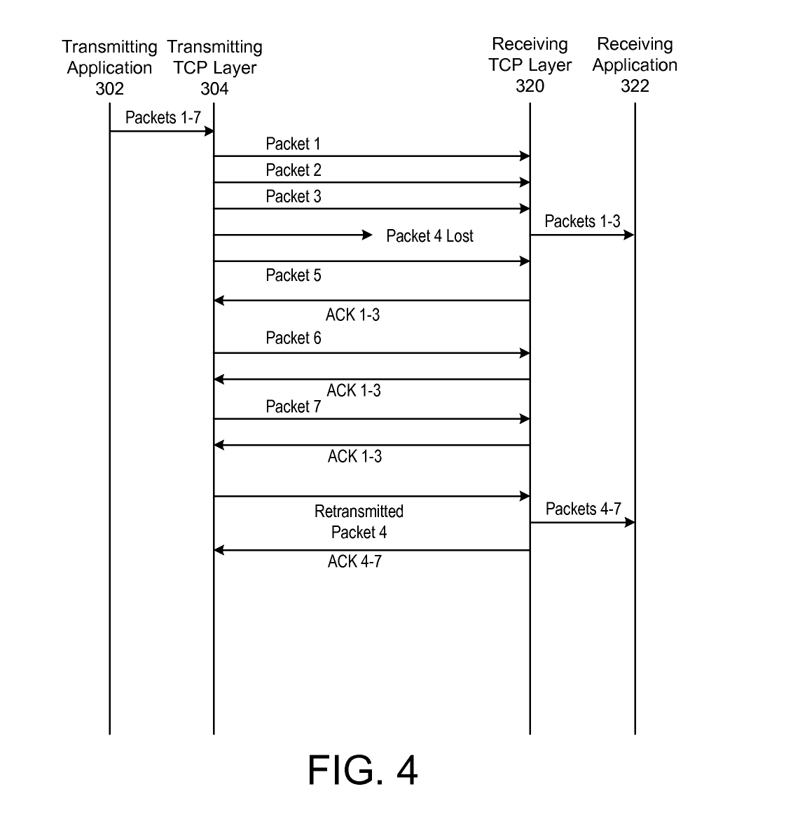

The network sequence diagram of FIG. 4 illustrates the operations of FIG. 3B in more detail. The transmitting application 302 provides packets 1-7 to the transmitting TCP layer 304. Packets 1-3 are provided to the receiving TCP layer 320 and then provided to the receiving application 322. Packet 4 is lost in transit. Packet 5 is received and the receiving TCP layer 320 provides an ACK packets 1-3. Packet 6 is received and the receiving TCP layer 320 provides another ACK of packets 1-3, the first DUP ACK. Packet 7 is received and the receiving TCP layer provides another ACK of packets 1-3, the second DUP ACK. The transmitting TCP layer 304 receives the second DUP ACK and then retransmits packet 4. Packet 4 is received at the receiving TCP layer 320, which then provides packets 4-7 to the application 322 and provides an ACK of packets 4-7.

It is also understood that the flowcharts are a simplification of any actual embodiment and are provided in simplified format to ease explanation of operation according to the present invention. It is further understood that the flowchart operations can be performed by hardware logic, a processor and firmware or software or a combination.

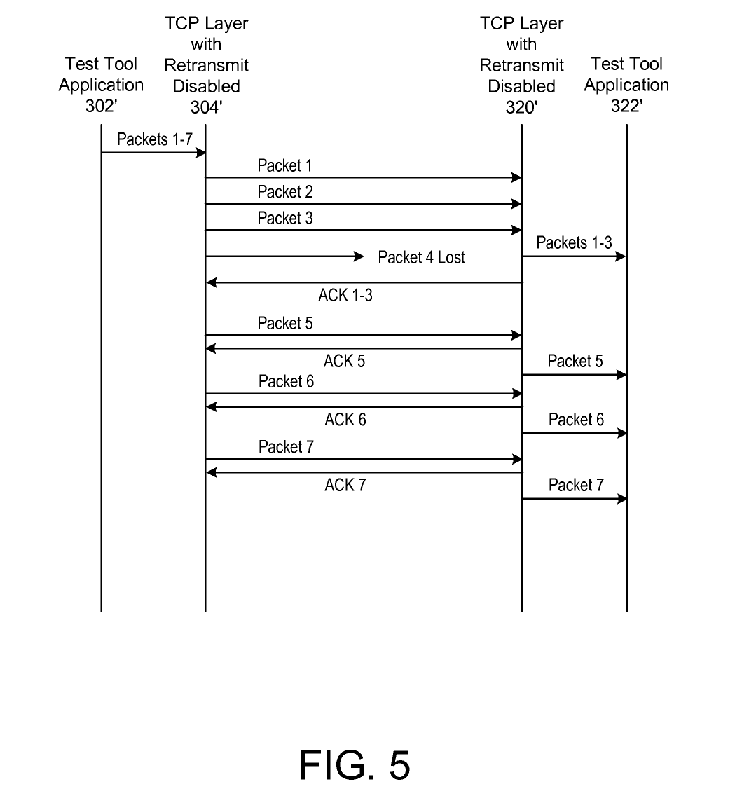

The network sequence diagram of FIG. 5 illustrates the operations of FIG. 3C in more detail. Packets 1-7 are provided from transmitting application 302′, such as the test tool 233, 235, to a transmitting TCP layer 304′, a modified version of the TCP layer 304. The packets 1-5 are provided to the LAN/WAN 312. Packets 1-3 are received by the receiving TCP layer 320′ but packet 4 is lost. Packets 1-3 are provided to the receiving application 322′. The receiving TCP layer 320′ provides an ACK of packets 1-3. Packet 5 is received and an ACK is provided, preferably with SACK information to indicate the loss of packet 4. Packet 5 is provided to the receiving application 322′. Packet 6 is also received and similarly an ACK of packet 6, preferably with a SACK indicating packet 4, is returned and packet 6 is provided to the receiving application 322′. Packet 7 is also received and similarly an ACK of packet 7, preferably with a SACK indicating packet 4, is returned and packet 7 is provided to the receiving application 322′. Thus no DUP ACKs have been provided even though packets are missing. The missing nature is provided in the SACK information, allowing the transmitting end to understand the presence of congestion.

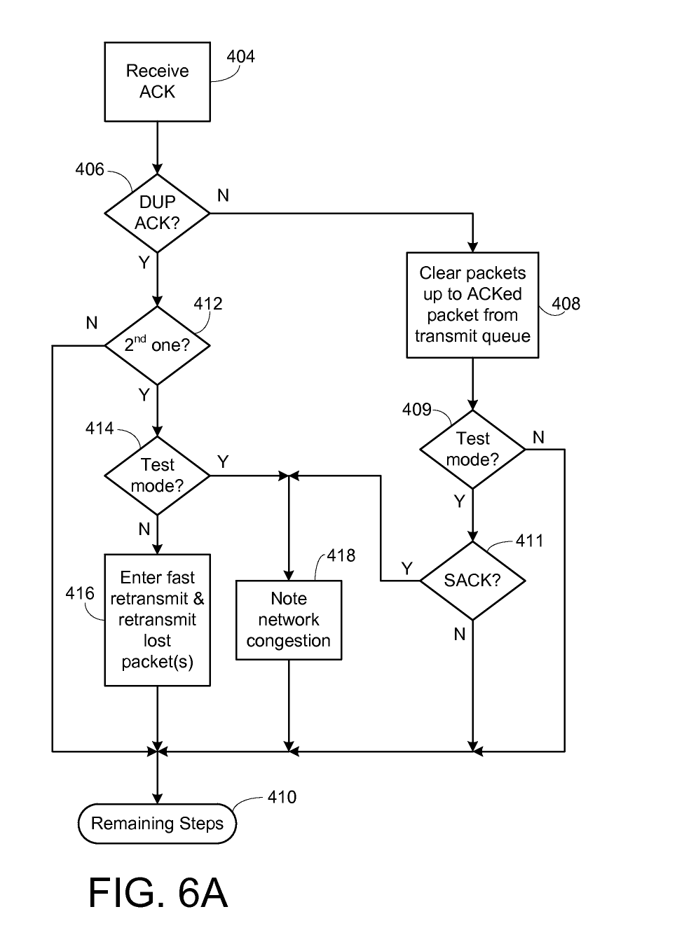

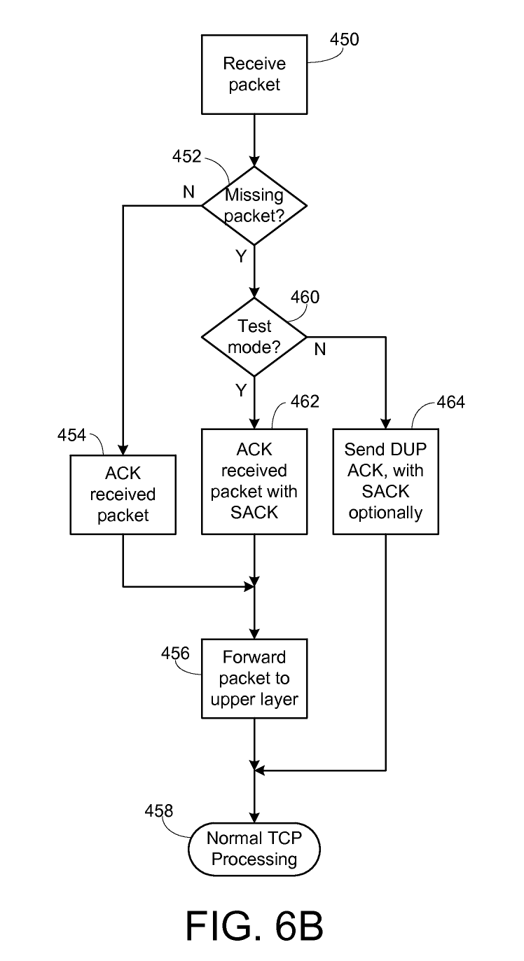

FIG. 6A is a flowchart of selected operations of the transmitting TCP layer 304′ according to the present invention. In step 404 an ACK is received. In step 406 a determination is made whether this is a DUP ACK. If not, in step 408 all packets up to and including the ACKed packet are removed from the transmit queue in the transmitting TCP layer 304′. If this is standard TCP operation, each packet will have been ACKed or at least received before the packets are cleared. In modified TCP operation, TCP Lite operation, according to the present invention, this may mean that lost packets, such as packet 4 in FIG. 3C, will be removed from the transmit queue without ever having been received. As discussed, above in TCP Lite delivery is not guaranteed and retransmission is not performed. This clearing of unACKed packets all transmit queue from filling with lost packets that will not be ACKed.

In step 409 a determination is made whether test mode is active. The TCP layer acts in test mode when operating in modified or TCP Lite mode. If not in test mode, in step 410 remaining TCP operations are performed. If in test mode, in step 411 a determination is made whether SACK information was included with the ACK. This case exists when the receiving TCP layer is also in test mode and a packet has been missed. As discussed above, this is an indication of network congestion, so if SACK information is present, operation proceeds to step 418 described below. If there is no SACK information, operation proceeds to step 410.

If the ACK is a DUP ACK as determined in step 406, then in step 412 a determination is made whether this is the second DUP ACK. If not, operation proceeds to step 410. If it is the second DUP ACK, in step 414 a determination is made whether the TCP layer 304 is operating in test mode. As discussed above, by properly selecting different ports, it is possible to do both standard TCP and TCP Lite operations at the same time. Preferably this would be done by executing two instantiations of the TCP layer, one configured for standard TCP operation and one for TCP Lite or test mode operation, with both TCP layers working with the single IP layer. If step 414 indicates this is not test mode but standard TCP operation, then step 416 causes the TCP layer to enter fast retransmit mode and the lost packets are retransmitted. Operations continue at step 410. If test mode is determined in step 414, then in step 418 the network congestion is noted but fast retransmit mode is not entered and packets are not retransmitted. It is noted that the preferred receiver operation described in FIG. 6 would not send DUP ACKs so that step 418 would normally be entered from step 411 but other embodiments may choose to send DUP ACKs to get the congestion noticed in step 418, so the test of step 414 is preferred in the transmitter operation.

FIG. 6B is the complementary flowchart of selected operations of the receiving TCP layer 320′. A data packet is received at step 450. Step 452 determines if the packet is in sequence or if there is a missing packet. If there is no missing packet, in step 454 an ACK is provided for the received packet. In step 456 the received packet is provided to the application layer, be it a normal application layer 322 or a test tool application 322′. In step 458 remaining normal TCP processing occurs.

If a packet was missing in step 452, step 460 determines if the TCP layer is in test mode. If so, in step 462 the received packet is ACKed with a SACK option. This is used to inform the transmitting TCP layer 304′ that there has been network congestion, though no retransmission is done. Next step 456 provides the received packet to the test tool application 322′. If the TCP layer is not in test mode in step 460, in step 464 a DUP ACK is provided, preferably with a SACK option included. This is normal TCP operation to trigger a retransmission of the missing packet. Normal TCP processing continues at step 458.

Operations with the SYN and FIN bits set is not described here as these packets operate with standard TCP processing, as discussed above.

It is understood that the test tool needs to be active on both IP gateways for proper operation.

As the TCP Lite or modified TCP layer provides packets promptly on their receipt and will skip lost packets, the diagnostic or test tool application can better diagnose the environment of the IP network. Thus more specialized test tools are not required, allowing broader use of a given test tool implementation without requiring extensive rewriting for each platform.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A transmission control protocol (TCP) receiver comprising:
a port for receiving and transmitting packets;
an Internet Protocol (IP) layer coupled to said port; and
a TCP layer coupled to said IP layer and for coupling to an application layer,
wherein said TCP layer has a first mode of operation that is generally conformant with standard TCP operations except that said TCP layer does not perform reordering, does not request retransmission and provides received packets to the application layer in the order received.

2. The TCP receiver of claim 1, wherein said TCP layer has a second mode of operation that is fully conformant with standard TCP operations and does perform reordering, does request retransmission and provides received packets to the application in sequence order.

3. The TCP receiver of claim 2, further comprising:
a second TCP layer coupled to said IP layer and for coupling to an application layer,
wherein said TCP layer operates in said first mode and said second TCP layer operates in said second mode.

4. The TCP receiver of claim 1, wherein said TCP layer provides an ACK with SACK information for each received packet that arrives when a packet is missing and does not provide DUP ACKs.

5. A transmission control protocol (TCP) transmitter comprising:
a port for receiving and transmitting packets;
an Internet Protocol (IP) layer coupled to said port; and
a TCP layer coupled to said IP layer and for coupling to an application layer,
wherein said TCP layer has a first mode of operation that is generally conformant with standard TCP operations except that said TCP layer does not perform retransmission and determines network congestion from received ACKs with SACK information.

6. The TCP receiver of claim 5, wherein said TCP layer has a second mode of operation that is fully conformant with standard TCP operations and does perform retransmission.

7. The TCP receiver of claim 6, further comprising:
a second TCP layer coupled to said IP layer and for coupling to an application layer,
wherein said TCP layer operates in said first mode and said second TCP layer operates in said second mode.

8. The TCP receiver of claim 5, wherein said TCP layer includes a transmit queue and said transmit queue is cleared of all packets up to the packet indicated in a received ACK.

9. A transmission control protocol (TCP) device comprising:
a port for receiving and transmitting packets;
an Internet Protocol (IP) layer coupled to said port; and
a TCP layer coupled to said IP layer and for coupling to an application layer, said TCP layer for both transmitting and receiving data,
wherein said TCP layer has a first mode of operation that is generally conformant with standard TCP operations except that said TCP layer does not perform reordering, does not request retransmission, does not perform retransmission, determines network congestion from received ACKs with SACK information and provides received packets to the application layer in the order received.

10. The TCP device of claim 9, wherein said TCP layer has a second mode of operation that is fully conformant with standard TCP operations and does perform reordering, does perform retransmission, does request retransmission and provides received packets to the application in sequence order.

11. The TCP device of claim 10, further comprising:
a second TCP layer coupled to said IP layer and for coupling to an application layer,
wherein said TCP layer operates in said first mode and said second TCP layer operates in said second mode.

12. The TCP receiver of claim 9, wherein said TCP layer provides an ACK with SACK information for each received packet that arrives when a packet is missing and does not provide DUP ACKs, and
wherein said TCP layer includes a transmit queue and said transmit queue is cleared of all packets up to the packet indicated in a received ACK.

13. A method comprising:
receiving transmission control protocol (TCP) packets from and providing TCP packets to an Internet Protocol (IP) layer; and
performing TCP operations in a first mode that is generally conformant with standard TCP operations except that said TCP operations do not include performing reordering or requesting retransmission and do include providing received packets to an application layer in the order received.

14. The method of claim 13, further comprising:
performing TCP operations in a second mode that is fully conformant with standard TCP operations and does include performing reordering, requesting retransmission and providing received packets to the application in sequence order.

15. The method of claim 14, wherein TCP operations in said first mode and said second mode are performed concurrently through a single port.

16. The method of claim 13, wherein said TCP operations include providing an ACK with SACK information for each received packet that arrives when a packet is missing and do not include providing DUP ACKs.

17. A method comprising:
receiving transmission control protocol (TCP) from and providing packets to an Internet Protocol (IP) layer;
performing TCP operations in a first mode of operation that is generally conformant with standard TCP operations except that said TCP operations do not include performing retransmission and do include determining network congestion from received ACKs with SACK information.

18. The method of claim 17, further comprising:
performing TCP operations in a second mode of operation that is fully conformant with standard TCP operations and does include performing retransmission.

19. The method of claim 18, wherein TCP operations in said first mode and said second mode are performed concurrently from a single port.

20. The method of claim 17, wherein a transmit queue holds packets that have been transmitted and
wherein said TCP operations include clearing the transmit queue of all packets up to the packet indicated in a received ACK.

21. A method comprising:
receiving transmission control protocol (TCP) packets from and providing TCP packets to an Internet Protocol (IP) layer; and
performing transmit and receive TCP operations in a first mode that is generally conformant with standard TCP operations except that said TCP operations do not include performing reordering, performing retransmission or requesting retransmission and do include providing received packets to an application layer in the order received and determining network congestion from received ACKs with SACK information.

22. The method of claim 21, further comprising:
performing transmit and receive TCP operations in a second mode that is fully conformant with standard TCP operations and does include performing reordering, performing retransmission, requesting retransmission and providing received packets to the application in sequence order.

23. The method of claim 22, wherein TCP operations in said first mode and said second mode are performed concurrently through a single port.

24. The method of claim 21, wherein a transmit queue holds packets that have been transmitted and
wherein said TCP operations include providing an ACK with SACK information for each received packet that arrives when a packet is missing and clearing the transmit queue of all packets up to the packet indicated in a received ACK and do not include providing DUP ACKs.
